(19) United States
(12) Patent Application Publication
(10) Pub. No.: US 2007/0045415 A1
(43) Pub. Date: Mar. 1, 2007

(54) Record player

(75) Inventor: Shimpei Usui, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/369,487

(22) Filed: Mar. 6, 2006

(30) Foreign Application Priority Data
Aug. 26, 2005 (JP) 2005-245239

(51) Int. Cl. G06K 7/00

(52) U.S. Cl. 235/435

(57) ABSTRACT

For the purpose of processing and editing the video data, which was recorded by means of the record player, in such a way as adding titles, playlists, menus, and other similar data, the conventional technique requires a processing and editing software operating on a personal computer. Such software is usually supplied together with the record player when purchased, in the form of recorded data media such as CD-ROM, but users are required to install the software by themselves. To solve the abovementioned problem, the present invention specifies that the software necessary for processing and editing on a personal computer the video data recorded by the record player is to be loaded in the hard disk recording media of the record player. Once the record player is connected to the data processing system, said software is automatically installed in the data processing system. In this way, operation for installation of said software is automated, leading to realization of improved usability of the record player. At the same time, reduction in product cost becomes possible, since said recorded data media containing said software can be dispensed with.

### BACKGROUND OF THE INVENTION

1. Field of the Invention

This invention relates to a record player.

2. Description of the Prior Art

Commercialized products of DVD recorders, camcorders, and other record players are usually mounted with hard disk drives as recording media. Descriptions are found in Japanese Published Unexamined Patent Application No. 2002-50155 with regard to a camcorder loaded with a hard-disk type recording media.

### SUMMARY OF THE INVENTION

The video data recorded with a record player is downloaded to a personal computer and then processed or edited so as to be added with titles, playlists, menus, and other data. To do such processing or editing, some software that is suitable for the aforesaid purposes and can run on personal computers is required.

Such software is usually supplied to the user in one package with the device, when the record player is purchased, and in the form of recorded data media such as CD-ROM along with a proper type of installer. However, the software supplied in such a manner is often bothersome to the user.

Thus, it is an object of the present invention to enhance usability of the record player by having the recorded data in such data recording media as CD-ROM transferred to the record player,

The record player of the present invention comprises image sensor, recording means to record the video data from the aforesaid image sensor in the recording media, reproducing means to playback the video data recorded by the aforesaid recording means, and communication means to transmit and receive data to/from the data processing system, and besides, the record player records the data other than the video data in the aforesaid recording media.

The present invention provides a record player that has an enhanced usability.

### BRIEF DESCRIPTION OF THE DRAWINGS

FIG. 1 is a block diagram of the record player of the present invention.

FIG. 2 is a diagram showing connection between the record player and the data processing system.

FIG. 3 is a schematic diagram of the directory structure of the hard disk recording media.

FIG. 4 is a flowchart showing the processing operation of automatic installation.

FIG. 5 is an example of display of the data processing system showing a message concerning confirmation of set-up start.

FIG. 6 is a flowchart of automatic display for document files.

FIG. 7 is an example of the instruction manual for the record player shown on the display of the data processing system.

### DESCRIPTION OF THE PREFERRED EMBODIMENTS

The embodiment of the present invention will now be described in conjunction with the above drawings. The embodiment explained here is a record player which is mounted with both a disk drive based on DVD or other types of optical disks and a hard disk drive together.

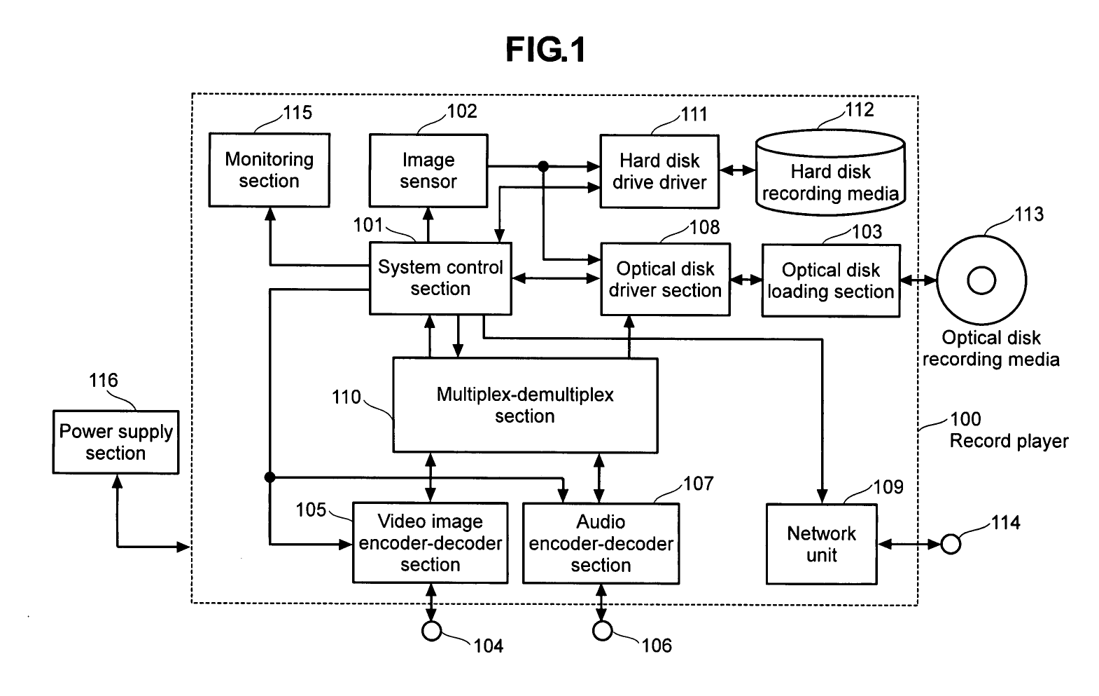

FIG. 1 is a block diagram of a camcorder. A record player is able to record input video and audio data in an optical disk recording media or a hard disk recording media and is also able to reproduce the data recorded as abovementioned. In recording video and audio data, both recording and reproduction are carried out in accordance with the specifications determined for each recording media. The hard disk recording media may be either built in the record player or of a removable (external) type. In the case of a removable type, the data stored in the hard disk recording media can be carried around and, therefore, can be transferred easily to other devices. Also a semiconductor memory or the like can achieve the effect similar to what is available with a hard disk recording media. In the present embodiment, the case in which a built-in hard disk recording media is used is to be described hereinafter. There is no limitation in the kind of DVD to be used. The foregoing is applicable to all disks in so far as they are pursuant to the respective specifications of DVD-RAM, DVD-R, DVD-RW, DVD+R, DVD+RW, and so forth. Not limited to DVDs, but BDs (Blu-ray Disk), an optical disk recording media featuring a large capacity, for example, are also qualified. In the present embodiment, a camcorder is taken up as an example of the record player for the sake of explanation. However, the applicable scope of the present invention is not limited to the camcorder but also extendable to stationary type recorders, mobile music players, and so forth.

FIG. 1 shows the record player 100. The system control section 101 controls the overall system. The image sensor 102 takes images of photographic subjects and performs photoelectric conversion of image data. The optical disk loading section 103 allows free insertion or withdrawal of an optical disk recording media 113 into or out of the loading section. The video input-output terminal 104 is used for input-output operation of digital video signal encoded or decoded in the video image encoder-decoder section 105. The audio input-output terminal 106 is used for input-output of audio signals encoded or decoded in the audio encoder-decoder section 107. The multiplex-demultiplex section 110 multiplexes compressed video data and compressed audio data output from the video encoder-decoder section 105 and the audio encoder-decoder section 107 to create stream data or otherwise demultiplexes the stream data into compressed video data and compressed audio data, both of which are then input to the video encoder-decoder section 105 and the audio encoder-decoder section 107 respectively. The optical disk drive driver section 108 functions, through the system control section 101, to write to the optical disk recording media 113 the stream data created by the multiplex-demultiplex section 110 and other various data files in a designated format or otherwise read out the stream data and other various data files stored in the optical disk recording media 113. The hard disk recording media driver section 111 functions, through the system control section 101, to write to the hard disk recording media 112 the stream data created by the multiplex-demultiplex section 110 and other various data files in a designated format or otherwise read out the stream data and other various data files from the hard disk recording media 112. The power supply section 116 supplies power, such as batteries and AC source, used for driving the record player.

The video encoder-decoder section 105, the audio encoder-decoder section 107, the multiplex-demultiplex section 110, the optical disk recording media driver section 108, and the hard disk recording media driver section 111; the circuitry for the foregoing sections may be configured so as to carry out hardware-like performance or otherwise, to execute software-like processing while having the functions of these sections stored as programs in the system control section 101. The optical disk recording media 113 and the hard disk recording media 112 are to mainly store files containing audio-visual data such as video data and audio data that are digitally compressed in data volume, and also file control information for these audio-visual data. The network unit 109 processes communication with the data processing system and other devices, provided with the communication input-output terminal 114. The monitoring section 115 displays the operation menu of the record player 100, the video data input from the image sensor 102, or the video data stored in the optical disk recording media or the hard disk recording media

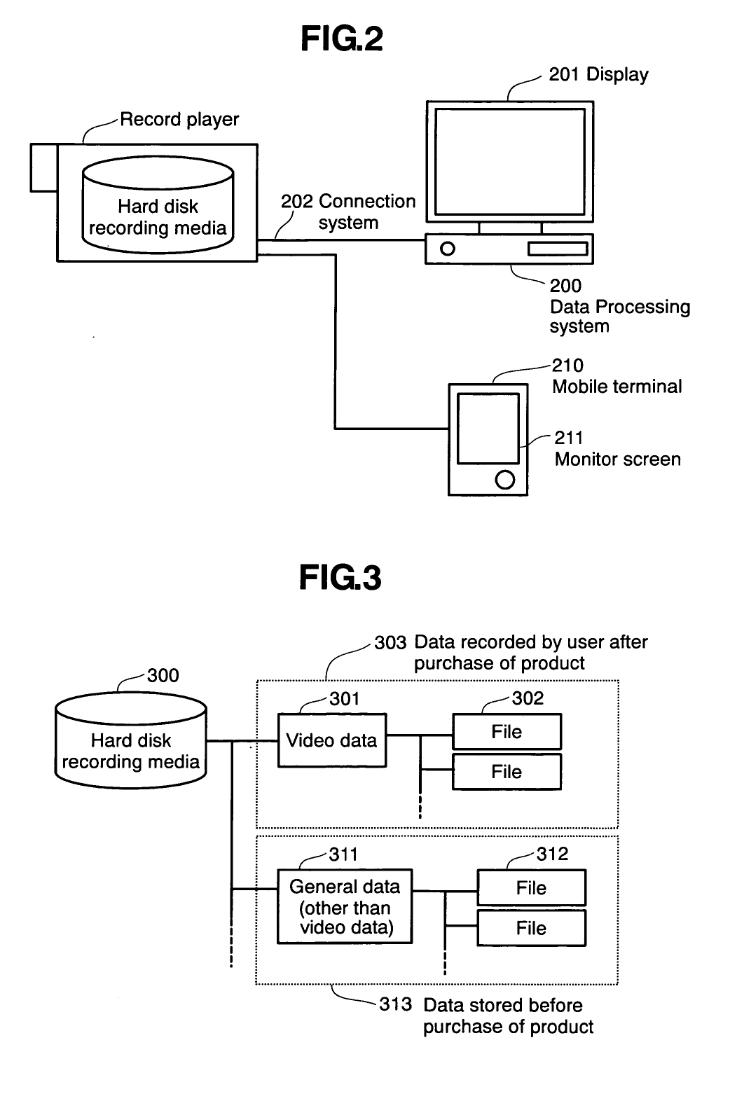

FIG. 2 is a diagram showing connection between the record player and the data processing system. The data processing system 200 has communication function to communicate with the record player 100 via the connection system, while also having the capability to install software used for processing or editing of video data. The display 201 provides monitor output of the data processing system. The connection system 202 provides connection means to keep the record player and the data processing system in a state communicable with each other. The connection means can be operated in whichever way of the cable system as represented by the use of USB cable and the wireless system as exemplified by the utilization of wireless LAN. The mobile terminal 210 has the monitor display 211. The data processing system may be composed of a personal computer of desktop type or note type, or a handheld terminal such as PDA and mobile-phone.

The aforesaid data processing system is assumed here as being an ordinary type of personal computer for the sake of explanation. The camcorder and the personal computer are also assumed to be provided with a general type of communication means. The camcorder and the personal computer are put in a communicable state when connected with each other by connection cable or other proper connection means. In this communicable state, transfer of files among the data processing systems makes various things possible to be carried out, such as to take in the video data recorded by the camcorder into the personal computer, to reproduce video in real time, and to edit video images by using some software for processing and editing of video images available on the market or specialized for use with the record player.

By utilizing the abovementioned software for processing and editing of video data installed on the aforesaid personal computer, it is possible to process or edit the video data in such a way as adding titles, playlists, menus, and other similar data to the above video data. The edited video data may be stored in the form of MPEG2 and MPEG4 files in the hard disk recording media of the personal computer.

FIG. 3 shows the structure of directory of the hard disk recording media mounted on the record player. The hard disk recording media 300 is mounted on the record player 100. The video data 301 is recorded in the record player 100. The files 302 compose the video data 301. The region 303 is where the video data is to be stored, and such video data includes the. files of digitally compressed audio-visual data such as the video data 301 recorded in the record player 100 and the files 302, as well as the control data for these audio-visual data. The video data 301 recorded in the record player 100 can be reproduced by means of the record player. The general data 311 is the data other than the video data 301, and the files 312 compose the general data 311. The general data region 313 stores the data for the data processing system and can store the data other than the video data 301 recorded by the record player. In other words, the data 311 intended for the general storage data other than the audio-visual content is accepted for storage in the hard disk recording media of the record player. Various data may be stored as the data 311, including the software for the data processing system, the driver of the data processing system, the instruction manual of the record player, or other files of computerized documents.

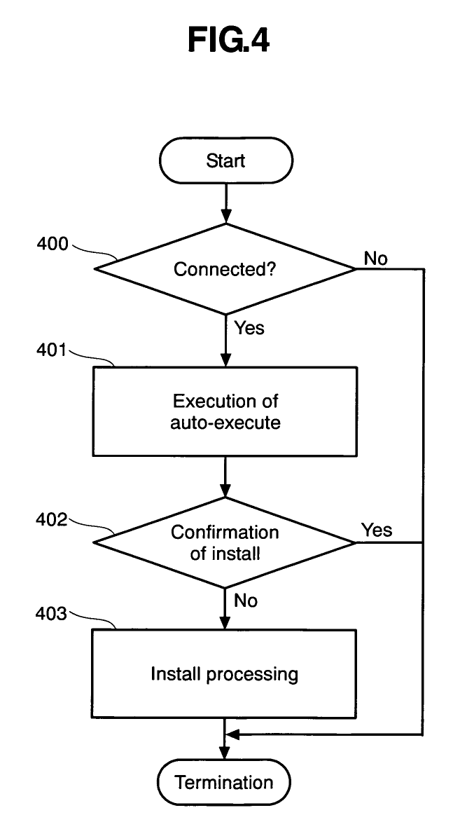

FIG. 4 is a flowchart showing the processing operation of auto-install in the data processing system. The auto-install program is stored in the hard disk recording media of the record player 100. When connection is completed between the record player and the data processing system enabling inter-device communication, the above program is transferred from the record player to the data processing system and executed on the operating system of the computer.

Now in reference to the flowchart shown in FIG. 4, operation of the record player is described in detail as follows. At the processing step 400, the record player, when it is connected to and becomes communicable with the data processing system via the connection system, responds to the request command sent from the data processing system, and the data processing system can detect from the response that connection is complete with the record player. If it is determined unconnected, operation is terminated. If determined connected, the operation proceeds to the processing step 401. The request command issued from the data processing system, if issued periodically, may take the form of periodic polling. Also, the device controller needs to be set out so that the record player may respond to the request from the data processing system. At the processing step 401, auto-execute program is executed. The program executed as above is a software to install some application software. At the processing step 402, it is to be determined if the data processing system has a required application software installed. If the above determination turns out that the application software is not installed, the install file is transferred from the record player 100 to the data processing system to execute install processing at the processing step 403. When installation is determined already done in the above determination, the processing is terminated. A series of event processing is thus terminated. After such series of event processing, it becomes possible for the user to utilize the application installed in the data processing system.

FIG. 5 is an example of display of the data processing system showing a message concerning confirmation of set-up start. The display 500 exhibits the monitor output of the data processing system. The message window 501 shows a message concerning the set-up operation to be started after connection is made between the record player and the data processing system.

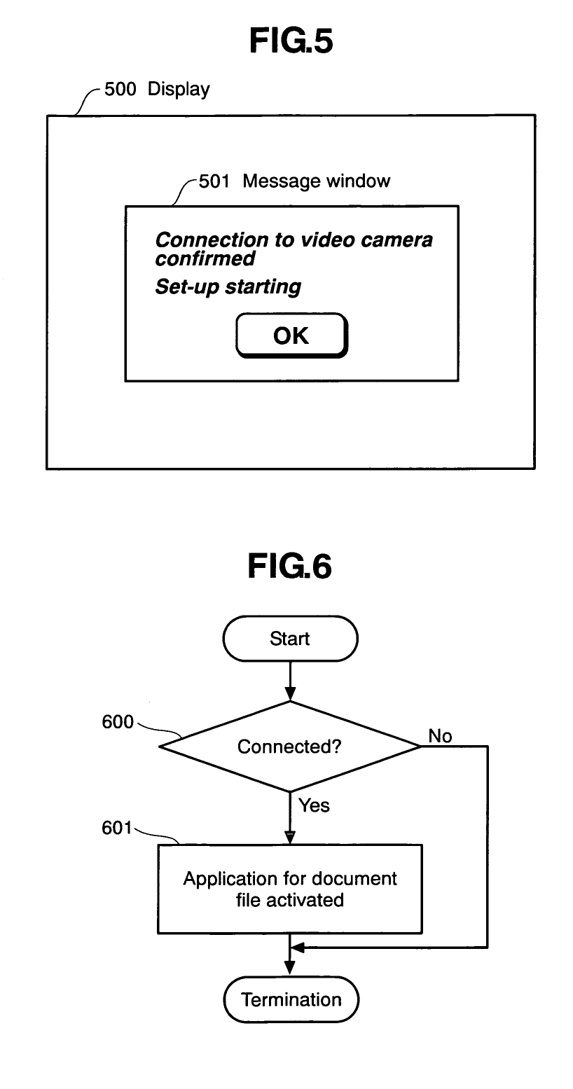

FIG. 6 is a flowchart of automatic display for the document files of the data processing system. At the processing step 600, determination is made as to whether the connection between the record player and the data processing system is detected or not. If the above determination turns out that connection is not completed, the processing is terminated. If the above determination confirms the connection is done, the document file is to be transferred from the record player 100 to the data processing system. Receiving the document file, the data processing system ascertains the kind of the document file and searches to see if any browsing application suitable for that kind of document file is installed in the data processing system. If a suitable type of browsing application software is not installed, an alarm display is inserted on the screen to alert the user to the absence of the application software. If existence of the browsing application is confirmed in the above determination, the browsing application for the document file is activated to open the document file and display its content on the screen of the data processing system.

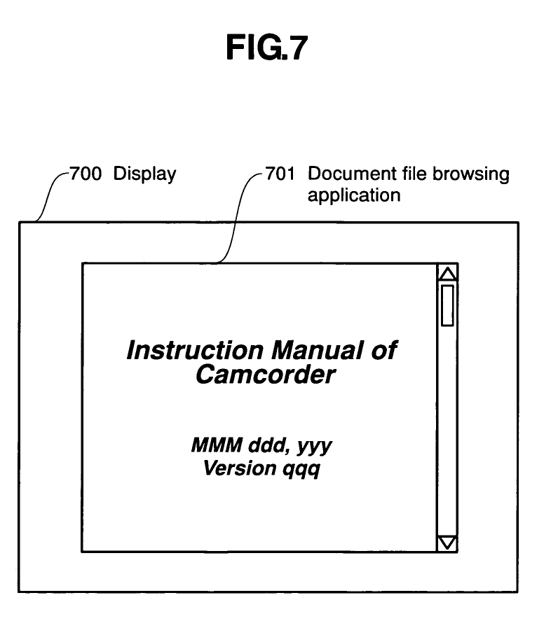

FIG. 7 is an example of the instruction manual for the record player shown on the display of the data processing system. The display 700 displays the monitor output of the data processing system. The window 701 displays the document file browsing application installed in the data processing system. In FIG. 7, a computerized document file in regard to the camcorder instruction manual is displayed as an example in the window of the document file browsing application 701. The document file is stored in the hard disk recording media of the record player 100.

The instruction manual of the record player can be displayed on the monitor screen of the data processing system connected to the record player during and in conjunction with the operation of the record player.

The instruction manual is stored in the hard disk recording media of the record player. The manual file stored in the hard disk can be deleted by the user if wanted. It is also possible to transfer the data from the terminal of the data processing system to the record player and have the data stored in the hard disk of the record player.

When the user who has purchased the record player wants to make user registration of the aforesaid record player with the maker for the purpose of receiving support services, the user may use the user registration program set up beforehand in the hard disk recording media of the record player. The user may thereby complete the user registration without difficulty.

When the record player with the user registration program set up in its hard disk recording media is connected to the data processing system connected to the Internet, the user registration program is automatically activated on the data processing system without any operation made by the user. From the hard disk recording media or the semiconductor memory of the record player, the user registration program serves to acquire a serial number that the maker assigns uniquely to the record player. The user registration program serves to make access via the Internet to the server, which provides the user registration function, and executes the user registration. All these steps of processing do not need any operation on the user's part. The user registration program can be activated also manually if wanted by the user.

The file of the automatic user registration program stored in the hard disk can be deleted by the user. Further, the data can be transferred from the terminal of the data processing system to the record player and stored in the hard disk of the record player.

A self-diagnostic program to check the system of the record player is stored in the hard disk recording media of the record player. The user can activate the self-diagnostic program on the record player or the data processing system and carry out self-diagnostic check of the record player on such items as the state of each device composing the record player, the state of recording of the optical disk recording media, and detection of faulty sectors of the hard disk recording media.

When the self-diagnostic program is operated on a data processing terminal connected to the Internet, the user can access the server that provides function to analyze the self-diagnostic results circumstantially and obtain from that server detailed diagnostic result or the ways of coping with the problem. The above process enables the user to obtain the aforesaid diagnostic resultor the ways of coping with the problem without any particular manipulation on the part of the user, insofar as the environment permits the data processing terminal to be connected to the Internet beforehand. Besides, it is also possible for the user to access the server by manual operation and obtain the foresaid diagnostic result or the ways of coping with the problem.

The file of the self-diagnostic program stored in the hard disk recording media can be deleted by the user if wanted. Even after the file is deleted, it is possible to transfer the data from the data processing terminal to the record player and store the data in the hard disk of the record player. Also, if the environment permits the data processing terminal to be connected to the Internet, it is possible to download the file of the self-diagnostic program from the server that provides the aforesaid program.

The system data of the record player is stored partially or wholly in the hard disk drive of the record player. The record player uses this system data to run the software. The system data stored in the hard disk recording media of the record player can be upgraded by connecting the record player and the data processing system and transferring from the data processing system to the record player the data necessary for upgrading of the system data of the record player.

It is also possible to upgrade the system data stored in the hard disk recording media of the record player by loading the optical disk recording media, in which the upgrading data of the record player is stored, into the optical disk drive of the record player.

The upgrading history remains in the hard disk recording media or the semiconductor memory of the record player. The user also has the option to delete upgraded items, that is, to downgrade the application.

It is also possible to upgrade the record player by accessing, by means of the data processing terminal connected to the Internet, the server providing the upgrading data for the record player and, further, by downloading and using the aforesaid data.

The user may change fonts, skins, and sound effects used for the liquid-crystal monitor screen of the record player. The data of these fonts, skins, and sound effects of the record player may be stored in the hard disk recording media of the record player. The aforesaid data may be added or deleted freely as desired by the user. Addition of data can be realized by connecting the record player and the data processing system and transferring the aforesaid data from the data processing system to the record player. Deletion of data can be made by deleting the corresponding file by way of operating the record player or the data processing terminal.

It is also possible to acquire the aforesaid data by accessing the server providing the aforesaid data by means of the data processing terminal connected to the Internet and by downloading the aforesaid data. Addition of the aforesaid data can be realized by transferring the aforesaid data downloaded in the data processing system, to the record player.

What is called “skin” herein means a setup for changing the appearance of the user interface of the application operating on the record player, such as pasting images of different design; or the images themselves to be pasted.

As exemplified by the above embodiments, operation to install the software required when the video data recorded with the record player are processed and edited by a personal computer is automated. It is obvious that such auto-install helps the record player enhance its usability.

The abovementioned software is usually supplied to the user in the form of CD-ROM or other data recording media included in the same package as the device. The present invention, however, does not need any such data recording media as aforesaid, thus making it possible to reduce the product cost. The user who requires the aforesaid data recording media is one who has a data processing system. Therefore, the aforesaid data recording media is not necessary at all from the beginning for the user who does not have any data processing system. Since the user who has a data processing system can download the aforesaid software through the Internet, the same user does not necessarily require the data recording media to come with the device included in one package.

On account that the record player is made possible to be treated as one of peripheral devices for the data processing system, the record player becomes available for the user for diversified purposes with its usability much improved.

What is claimed is:

1. A record player comprising:
an image sensor,
a recording means to record the video data from said image sensor in a recording media,
a reproducing means to reproduce the video data recorded in said recording means, and
a communicating means to transmit or receive data to or from a data processing system,
wherein some other data than the video data, in addition to said video data, is recorded in said recording media.

2. The record player according to claim 1, wherein said record player further comprises a connection system to connect to said data processing system and, when connected to said data processing system by means of said connection system, transmits the data other than said video data to said data processing system automatically.

3. The record player according to claim 2, wherein said data other than said video data is a software operating on said data processing system and, when said record player is connected to said data processing system by means of said connection system, said software is automatically installed in said data processing system.

4. The record player according to claim 2, wherein the data other than said video data is a document file and, when said record player is connected to said data processing system by means of said connection system, the content of said document file is automatically displayed on the screen of said data processing system.

5. The record player according to claim 1, wherein the data other than said video data is at least one among software, installer, and driver of said data processing system.

6. The record player according to claim 1, wherein the data other than said video data is the system program of the record player, and the operation of said system program controls the system of the record player.

7. The record player according to claim 1, wherein the data other than said video data is the system program of the record player and the collaboration of the system program operating on the record player and the program operating on the data processing system controls the system operation of the record player.

8. The record player according to claim 1, wherein said recording media is a hard disk recording media.
